(19) United States
(12) Patent Application Publication
(10) Pub. No.: US 2013/0132521 A1
(43) Pub. Date: May 23, 2013

(54) PRESENTING ALTERNATIVE MEDIA CONTENT BASED ON ENVIRONMENTAL FACTORS

(71) Applicants: Benedito J. Fonseca, JR., Glen Ellyn, IL (US); Kevin L. Baum, Rolling Meadows, IL (US); Faisal Ishtiaq, Chicago, IL (US); Michael L. Needham, Palatine, IL (US)

(72) Inventors: Benedito J. Fonseca, JR., Glen Ellyn, IL (US); Kevin L. Baum, Rolling Meadows, IL (US); Faisal Ishtiaq, Chicago, IL (US); Michael L. Needham, Palatine, IL (US)

(73) Assignee: GENERAL INSTRUMENT CORPORATION, Horsham, PA (US)

(21) Appl. No.: 13/303,236

(22) Filed: Nov. 23, 2011

(51) Int. Cl. G06F 15/16

(52) U.S. Cl. 709/219

(57) ABSTRACT

The environment surrounding an end-user device is analyzed. When a user of the device requests a download of a media presentation, the device uses the results of the environmental analysis to automatically request an alternative audio or video track for the media presentation. By choosing a better alternative before the download even begins, the device avoids user frustration and conserves resources. For example, a user requests a music video to be played on his mobile phone. By using its microphone, the phone analyzes its current audio environment and concludes that there is considerable background noise. Then when requesting a download of the music video, the phone requests an “enhanced-clarity” soundtrack to increase the odds that its user will be able to hear the music over the background noise. In some situations, the alternative track is rendered in addition to, rather than instead of, the default tracks of the media presentation.

### FIELD OF THE INVENTION

The present invention is related generally to data-delivery systems and, more particularly, to systems that send or receive media presentations.

### BACKGROUND OF THE INVENTION

More and more users are downloading more and more media presentations to more and more devices. (Here, “media presentations” generally include just about any kind of digital content, and, more specifically, sound, video, and interactive files including games.) These media presentations are often enormous, and downloading them can consume a significant amount of available bandwidth and battery power on the user's device.

In order to manage download requests, download servers often divide a large media presentation into consecutive “chunks” where each chunk represents, for example, a few seconds of video. When a user wishes to consume a media presentation, his device begins by requesting a “playlist” for the presentation from the download server. (Note that here “consume” is meant as a general term for any type of human interaction with a medium. It can include watching television, listening to radio, playing a computer game, talking or texting on a telephone, interacting with a web site, and the like. To simplify the present discussion, a media consumer is generally called a “user” or a “viewer,” even when his medium of choice does not have a visual portion.) The playlist includes a list of descriptions of the chunks into which the presentation is segmented on that server (including alternative resolutions). With the playlist in hand, the user's device asks the server to download the first chunk of the presentation. While the user is viewing the first chunk, his device attempts to “keep ahead” of the user's viewing (and thus avoid “video freeze”) by requesting subsequent chunks of the presentation. The chunks are received and buffered on the user's device so that the user can continue to view the media presentation while subsequent chunks are still being delivered.

The chunked-download model described above is not suitable to every situation, however. Consider, for example, a user who wishes to view a media presentation on a personal communications device (e.g., a cell phone or tablet computer) in a less than optimal environment, maybe in a noisy neighborhood bar. When he requests the presentation, his device begins to download and play the chunks listed on the playlist. But the user may soon realize that, because of the volume of background noise, he cannot hear the audio track. Rather than giving up entirely, he decides to watch the presentation with close-captioning turned on. Generally, closed-captioning (when available at all) is including in a different version of the presentation. To get it, the user aborts the current download and recommences by requesting a download that includes the closed-captioning content. Often, this forces his personal device to discard the chunks already downloaded, request a different playlist (for the version of the presentation that includes close-captioning), and then recommence the download. This causes a frustrating delay for the user and, in addition, wastes significant resources of battery power on his device and download bandwidth.

### BRIEF SUMMARY

The above considerations, and others, are addressed by the present invention, which can be understood by referring to the specification, drawings, and claims. According to aspects of the present invention, the environment surrounding an end-user device is analyzed. When a user of the device requests a download of a media presentation, the device uses the results of the analysis of the environment to automatically request an alternative audio or video track for the media presentation. By choosing a better alternative before the download even begins, the end-user device avoids user frustration and conserves resources.

For example, a user requests a music video to be played on his mobile phone. By using its microphone, the phone analyzes its current audio environment and concludes that there is considerable background noise. Then when requesting a download of the music video, the phone requests an “enhanced-clarity” soundtrack to increase the odds that its user will be able to hear the music over the background noise.

As another example, extreme lighting or other environmental factors may cause the end-user device to select as an alternative an enhanced-clarity video track or a summary track. If the end-user device can sense social-presence information, then it may request a censored video track as the alternative track. Depending upon the nature of the alternative track, the alternative can be rendered in addition to, rather than instead of, the default tracks of the requested media presentation. Other examples of environmental factors and corresponding alternative tracks are discussed below.

Before actually requesting the download, the device may recommend to its user that an alternative track be downloaded. The user can then decide whether to accept the recommendation or to download the default track.

In some embodiments, the analyzing is performed by a remote server that receives environmental samples from the end-user device.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of the end-user device shown in FIG. 1; and

FIG. 3 is a flowchart of a method performed by a representative end-user device.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

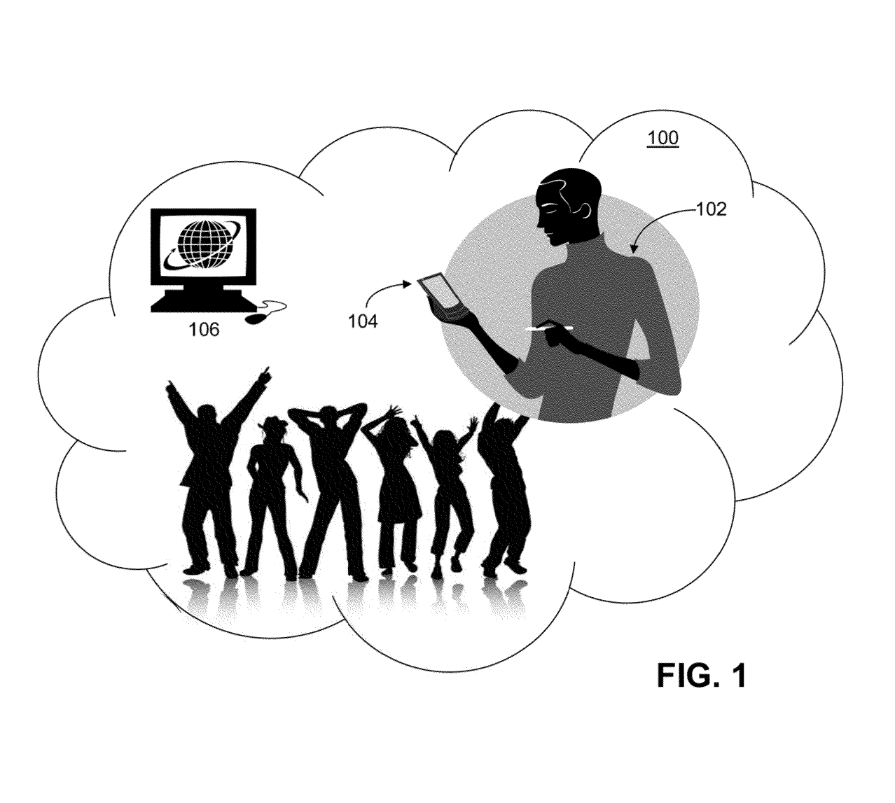

Aspects of the present invention may be practiced in the representative communications environment 100 of FIG. 1. A user 102 wishes to download a media presentation from a media-download server 106 and then watch the presentation on his end-user device 104 (e.g., a cell phone or tablet computer). However, the user 102 is currently in a neighborhood bar that is both noisy and inappropriately lighted for viewing purposes. Traditionally, the user 102 would request the download and begin playing the presentation. Only then would he notice that he either cannot hear the audio track or clearly perceive the video track. The user 102 would be frustrated and might give up, leave, or stop the download and request a version of the media presentation more suitable to his current environmental conditions.

Because the user's device 104 implements an embodiment of the present invention, however, the user 102 is saved from this frustration. When the device 104 receives the download command, it automatically analyzes its environment. It detects the loud noise and the poor lighting. When the device 104 requests the download, it specifies an alternative audio or video track (assuming that these are available on the media-download server 106). Then when the media presentation is rendered to the user 102, the alternative track enables the user 102 to perceive the presentation as well as possible, given the less than optimal environment.

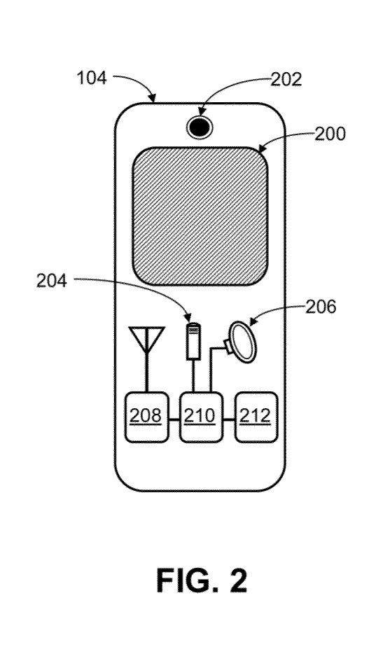

FIG. 2 shows an end-user device 104 that incorporates an embodiment of the present invention. Typically, the main display 200 is used for most high-fidelity interactions with the user 102. For example, the main display 200 is used to show video or still images, is part of a user interface for changing configuration settings, and is used for viewing call logs and contact lists. To support these interactions, the main display 200 is of high resolution and is as large as can be comfortably accommodated in the device 104. A device 104 may have a second and possibly a third display screen for presenting status messages. These screens are generally smaller than the main display screen 200. They can be safely ignored for the remainder of the present discussion. A typical user interface of the device 104 can include, in addition to the main display 200, a camera 202, a microphone 204 (or two), a speaker 206, and other input or output devices. FIG. 2 also illustrates some of the more important internal components of the device 104. The device 104 includes a network interface subsystem 208, an environmental subsystem 210 that controls the input and output devices, and a processor 212.

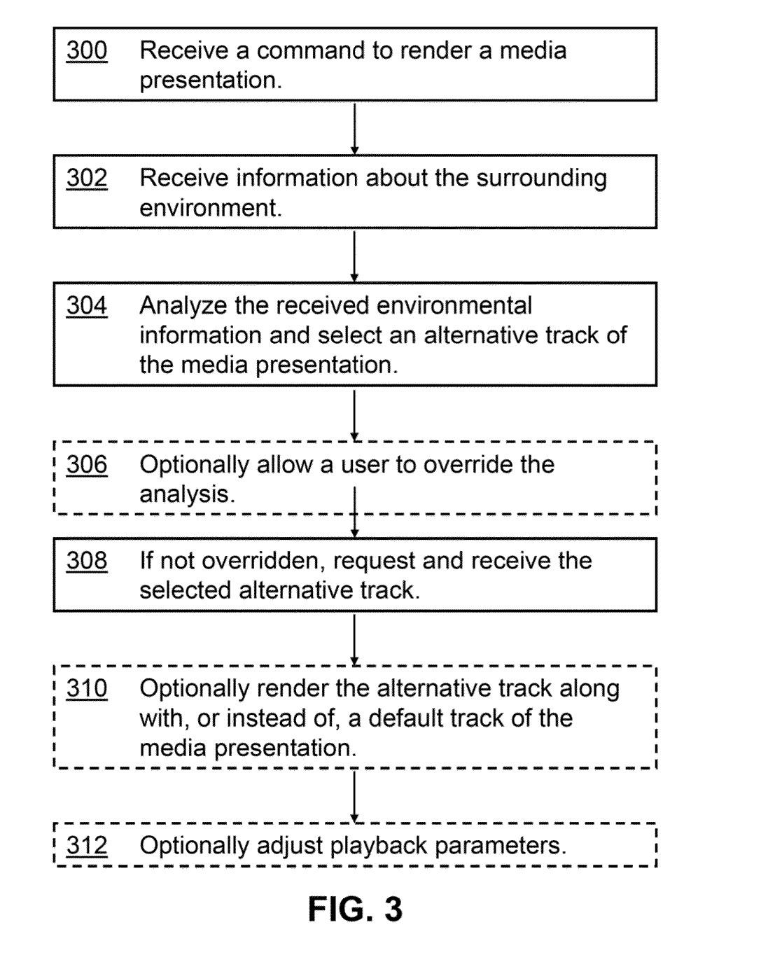

The end-user device 104 can use the method illustrated in FIG. 3. (For the sake of simplicity, FIG. 3 shows the method as fully embodied on the device 104, but in other embodiments the method is in a combination of this device 104 and a web server.) In step 300, the user 102 directs his device 104 to download and play a media presentation. (In some situations, the command of step 300 comes from an entity other than the user 102. An application running on the device 104 or on a remote server determines, without an explicit command from the user 102, that the device 104 should download and play a presentation. For example, an alarm-clock application could do this every morning at a set time.)

The device 104 receives information about its surroundings in step 302. (Note that in some embodiments, the device 104 is constantly monitoring its environment: Step 302 need not be triggered by the download command of step 300. In other embodiments, the device 104 performs step 302 when it expects that its user will soon send a download command.) Any type of environmental information may be gathered here. The volume of the background noise is determined by the microphone 204, and the camera 202 determines the lighting conditions. These inputs can be processed, possibly with the help of a remote server, to extract even more information. For example, the noise can be analyzed to determine if an identifiable media presentation is being played by a device other than the user's device 104. (If the requested presentation is the same as the one already being played by a different device, then the device 104 may simply not play the audio to prevent dissonance.) The type of noise might be indicative of a particular type of environment, e.g., a bar, a quiet party, or a lecture. It is possible that a voice can be extracted from the noise and the speaker identified. Other sensors (including Bluetooth's device discovery) can be used to try to determine social-presence information, that is, who is near to the user 102. If the device 104 has a GPS sensor, then it can consult a map and know where it is and what type of environment to expect. A device other than the device 104 could sense the environment and send information to the device 104 for use in step 304 (see discussion below).

As much environmental information is gathered as possible and used in the analysis of step 304. The analysis guides the selection of an alternative track to download that should make the user's experience more enjoyable. In the example above, a loud environment might lead to the choice of an “enhanced-clarity” audio track, that is, one that emphasizes distinctions of sound so that speech, for example, may be more easily made out. Another example of an “enhanced-clarity” audio track reduces the dynamic range of the audio energy, thus allowing for better listening of the low-energy portions of the audio. Another audio track enhances audibility by increasing or decreasing energies in specific portions of the audio spectrum. Speech can be replaced by synthesize speech. Poor lighting conditions can similarly lead to the selection of an enhanced-clarity video track or even a cartoon version of the video. Brightness or contrast can be enhanced, or the dynamic range of brightness or contrast compressed. Edge enhancement, where the contrast is increased around the edges of objects detected in the video, can be used to sharpen the image. Another alternative track is a “partial-information” track. A partial-information audio track contains only some of the original audio track, for example, only the speech and not the background music. A partial-information video track contains only some of the video elements of the original video track. For example, a partial-information video sequence contains only the people and foreground objects but not the irrelevant background images. Another partial-information video track “pans and scans,” that is, it constantly finds the most important region of the video image and magnifies that portion. The alternative video track may also be “graphically enhanced” to contain graphical elements that highlight portions of the video in order to facilitate the user's perception. Examples of graphical elements include arrows which point to objects in the video and geometrical shapes that surround objects in the video.

Non-environmental information can also be used in the selection of an alternative track in step 304. General demographic information or profile information specific to this user 102 may be applied. If, for example, the user 102 only speaks Spanish, then a Spanish-language alternative audio track may be requested if the default track is in English. If the user 102 requests a long download, but the device 104 knows that its user 102 has too little time to view the entire presentation (e.g., the device 104 has access to a calendaring application), then the device 104 can request a summary of the presentation rather than the entire presentation.

Environmental and non-environmental information can both be considered in step 304. If the device 104 senses the presence of the children of the user 102, then it can consult preferences in the user's profile and, perhaps, request a censored audio or video track (or both). Other possible types of environmental and non-environmental information can be easily considered by the device 104.

Step 306 is technically optional but is important in many cases. Here, the device's choice of an alternative track is presented to the user 102 for review. The user 102 may accept the alternative, may reject it for the default, or may select another alternative. The user 102 may also realize that his device 104 considers that the environmental conditions are not at present very good and consequently postpone the download until he can get to a quieter place.

If the device's selection of an alternative track is not overridden in step 306, then the device 104 begins to download the alternative in step 308. The process of steps 302 through 308 can continue during the presentation and if, for example, the playback environment improves, the device 104 can stop requesting the alternative track and simply request the default tracks. Alternatively, if the user 102 keeps turning up the volume during playback, then the device 104 can request an enhanced-clarity audio track if it has not done so already.

Note that, according to aspects of the present invention, the device 104 does not create an alternative track. It consults the media-download server 106 to see what alternatives are available and, based on the environmental and other information at hand, decides which of the available alternatives would be best.

Depending on circumstances, the selected alternative may be rendered along with, or instead of, a default track of the media presentation in step 310. An enhanced-clarity audio or video track would replace its default track. A commentary track may be suitable for playing along with the default tracks.

Still monitoring the environment, the device 104 can automatically change various playback parameters in step 312 to make the audio louder or to enhance the contrast of the audio or video tracks.

In view of the many possible embodiments to which the principles of the present invention may be applied, it should be recognized that the embodiments described herein with respect to the drawing figures are meant to be illustrative only and should not be taken as limiting the scope of the invention. For example, other environmental and non-environmental clues can be analyzed when selecting an appropriate alternative track. Therefore, the invention as described herein contemplates all such embodiments as may come within the scope of the following claims and equivalents thereof.

We claim:

1. A method for an end-user device to receive media content, the method comprising:
receiving, by the end-user device, a command to render a media presentation;
receiving, by the end-user device, information about an environment of the end-user device;
analyzing at least a portion of the received environmental information;
based, at least in part, on the analyzing, sending a request for a chunk of an alternative audio or video track associated with the media presentation; and
receiving, by the end-user device, the requested chunk of the alternative track.

2. The method of claim 1 wherein the end-user device is selected from the group consisting of: a mobile telephone, a set-top box, a digital video recorder, a personal computer, a tablet, a home gateway, a media-restreaming device, and a gaming console.

3. The method of claim 1 wherein the environmental information comprises an element selected from the group consisting of: a volume of sound, an identification of a media presentation being played by a device distinct from the end-user device, a type of background noise, a lighting condition, a geo-location of the user device, an identification of a person who is speaking, and social-presence information.

4. The method of claim 1 wherein the analyzing is performed by a server distinct from the end-user device.

5. The method of claim 1 wherein sending a request is further based on an element selected from the group consisting of: command input from a user of the end-user device, a profile of the user of the end-user device, demographics, and social-presence information.

6. The method of claim 1 wherein the alternative track comprises an element selected from the group consisting of: audio in a language different from a default language associated with the media presentation, enhanced-clarity audio, censured audio, a commentary track, partial-information audio, enhanced-clarity video, censured video, a cartoon version of the video, partial-information video, graphically enhanced video, and summarized content.

7. The method of claim 1 further comprising:
rendering the media presentation along with the associated alternative track.

8. The method of claim 7 wherein the associated alternative track is rendered in addition to a default track associated with the media presentation.

9. The method of claim 8 further comprising:
adjusting a playback volume of the default audio track.

10. The method of claim 7 wherein the associated alternative track is rendered instead of a default track associated with the media presentation.

11. The method of claim 1:
wherein the alternative track comprises enhanced-clarity video; and
wherein the method further comprises:
rendering the enhanced-clarity video instead of a default video track of the media presentation.

12. The method of claim 1 further comprising:
presenting, by the end-user device to a user of the end-user device, an indication of the requested alternative audio or video track; and
receiving, by the end-user device from the user of the end-user device, a command overriding the requested alternative audio or video track.

13. An end-user device configured for receiving media content, the end-user device comprising:
an environmental subsystem configured for receiving information about an environment of the end-user device;
a network interface subsystem; and
a processor operatively connected to the environmental subsystem and to the network interface subsystem and configured for:
receiving a command to render a media presentation;
analyzing at least a portion of the received environmental information;
based, at least in part, on the analyzing, sending, via the network interface subsystem, a request for a chunk of an alternative audio or video track associated with the media presentation; and
receiving, via the network interface subsystem, the requested chunk of the alternative track.

14. The end-user device of claim 13 wherein the end-user device is selected from the group consisting of: a mobile telephone, a set-top box, a digital video recorder, a personal computer, a tablet, a home gateway, a media-restreaming device, and a gaming console.

15. The end-user device of claim 13 wherein the environmental information comprises an element selected from the group consisting of: a volume of sound, an identification of a media presentation being played by a device distinct from the end-user device, a type of background noise, a lighting condition, a geo-location of the user device, an identification of a person who is speaking, and social-presence information.

16. The end-user device of claim 13 wherein sending a request is further based on an element selected from the group consisting of: command input from a user of the end-user device, a profile of the user of the end-user device, demographics, and social-presence information.

17. The end-user device of claim 13 wherein the alternative track comprises an element selected from the group consisting of: audio in a language different from a default language associated with the media presentation, enhanced-clarity audio, censured audio, a commentary track, partial-information audio, enhanced-clarity video, censured video, a cartoon version of the video, partial-information video, graphically enhanced video, and summarized content.

18. The end-user device of claim 13 wherein the processor is further configured for:
rendering the media presentation along with the associated alternative track.

19. The end-user device of claim 18 wherein the associated alternative track is rendered in addition to a default track associated with the media presentation.

20. The end-user device of claim 19 wherein the processor is further configured for:
adjusting a playback volume of the default audio track.

21. The end-user device of claim 18 wherein the associated alternative track is rendered instead of a default track associated with the media presentation.

22. The end-user device of claim 13:
wherein the alternative track comprises enhanced-clarity video; and
wherein the processor is further configured for:
rendering the enhanced-clarity video instead of a default video track of the media presentation.

23. The end-user device of claim 13 wherein the processor is further configured for:
presenting, to a user of the end-user device, an indication of the requested alternative audio or video track; and
receiving, from the user of the end-user device, a command overriding the requested alternative audio or video track.
